(19) United States
(12) Patent Application Publication
(10) Pub. No.: US 2019/0007589 A1
(43) Pub. Date: Jan. 3, 2019

(54) CAMERA INITIALIZATION FOR MULTIPLE CAMERA DEVICES

(71) Applicant: QUALCOMM Incorporated, San Diego, CA (US)

(72) Inventors: Ravi Shankar Kadambala, Hyderabad (IN); Soman Nikhara, Hyderabad (IN); Pradeep Veeramalla, Hyderabad (IN); Bapineedu Chowdary Gummadi, Hyderabad (IN)

(21) Appl. No.: 15/640,175

(22) Filed: Jun. 30, 2017

(51) Int. Cl. H04N 5/225; H04N 5/232; H04N 13/02

(52) U.S. Cl. CPC H04N 5/2258; H04N 13/0296; H04N 5/23293; H04N 5/23216

(57) ABSTRACT

Methods and devices for camera initialization are disclosed. In some aspects, a device includes a first camera to capture one or more first image frames, a second camera to capture one or more second image frames, and a camera controller coupled to the first camera and the second camera. The camera controller is configured to initialize the first camera, to cause the second camera to capture one or more second image frames while initializing the first camera, to determine an initial capture setting for the first camera based on the one or more second image frames captured by the second camera, and to complete initialization of the first camera using the initial capture setting.

### TECHNICAL FIELD

The present disclosure relates generally to controlling cameras, and specifically to initializing one or more cameras of a device.

### BACKGROUND

Many electronic devices, such as smartphones, tablets home security systems, automobiles, drones, and aircraft, use multiple cameras to capture images and video. Each of the multiple cameras is initialized prior to use, for example, by determining one or more initial settings (such as an initial auto exposure setting and an initial white balance setting) for each camera and then applying the determined initial settings to each of the multiple cameras. Each of the multiple cameras is typically initialized independently of the other cameras, which may cause an undesired latency (such as an amount of time between a given camera being powered on and the given camera being ready to capture images or video).

It is desirable to reduce the latencies associated with initializing one or more cameras of a device, for example, to increase the speed with which a camera may be ready to capture images or video.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter.

Aspects of the present disclosure are directed to methods and devices for initializing one or more cameras of a device. In some aspects, a device is disclosed that includes a camera controller coupled to a first camera and a second camera. The camera controller is configured to initialize the first camera to capture one or more first image frames, to cause the second camera to capture one or more second image frames while initializing the first camera, to determine an initial capture setting for the first camera based on the one or more second image frames captured by the second camera, and to complete initialization of the first camera using the initial capture setting.

In another aspect, a method is disclosed for initializing one or more cameras of a device. The method includes initializing a first camera to capture one or more first image frames, causing a second camera to capture one or more second image frames while initializing the first camera, determining an initial capture setting for the first camera based on the one or more second image frames captured by the second camera, and completing initialization of the first camera using the initial capture setting.

In another aspect, a non-transitory computer-readable storage medium is disclosed. The non-transitory computer-readable storage medium may store one or more programs containing instructions that, when executed by one or more processors of a device, cause the device to perform a number of operations. The number of operations may include initializing a first camera to capture one or more first image frames, causing a second camera to capture one or more second image frames while initializing the first camera, determining an initial capture setting for the first camera based on the one or more second image frames captured by the second camera, and completing initialization of the first camera using the initial capture setting.

In another aspect, a device is disclosed. The device may include means for initializing a first camera to capture one or more first image frames, means for causing a second camera to capture one or more second image frames while initializing the first camera, means for determining an initial capture setting for the first camera based on the one or more second image frames captured by the second camera, and means for completing initialization of the first camera using the initial capture setting.

### BRIEF DESCRIPTION OF THE DRAWINGS

Aspects of this disclosure are illustrated by way of example, and not by way of limitation, in the figures of the accompanying drawings and in which like reference numerals refer to similar elements.

FIG. 1A depicts an example device including multiple cameras.

FIG. 1B depicts another example device including multiple cameras.

FIG. 2 is a block diagram of an example device including multiple cameras.

FIG. 3 is an illustrative flow chart depicting an example operation for initializing a camera.

FIG. 4 is an illustrative flow chart depicting an example operation for initializing a first camera based at least in part on images captured by a second camera.

FIG. 5 is an illustrative flow chart depicting an example operation for initializing a first camera to capture image frames at a first frame rate.

FIG. 6 is an illustrative flow chart depicting an example operation for concurrently initializing a first camera and a second camera.

FIG. 7 is an illustrative flow chart depicting another example operation for initializing a first camera and a second camera.

FIG. 8 is an illustrative flow chart depicting an example operation for determining one or more initial capture settings for a first camera during initialization.

### DETAILED DESCRIPTION

Aspects of the present disclosure may allow an electronic to initialize one or more cameras, and may be applicable to any electronic having or coupled to a plurality of cameras (such as a consumer device with a dual camera). In some implementations, a device (which may be any electronic that may implement aspects of the disclosure) may include a camera controller coupled to a first camera and a second camera. The camera controller may be configured to initialize the first camera to capture one or more first image frames, to cause the second camera to capture one or more second image frames while initializing the first camera, to determine an initial capture setting for the first camera based on the one or more second image frames captured by the second camera, and to complete initialization of the first camera using the initial capture setting. In this manner, aspects of the present disclosure may allow an electronic to reduce the time required to initialize a camera for capturing one or more images.

In the following description, numerous specific details are set forth such as examples of specific components, circuits, and processes to provide a thorough understanding of the present disclosure. The term “coupled” as used herein means connected directly to or connected through one or more intervening components or circuits. Also, in the following description and for purposes of explanation, specific nomenclature is set forth to provide a thorough understanding of the present disclosure. However, it will be apparent to one skilled in the art that these specific details may not be required to practice the teachings disclosed herein. In other instances, well-known circuits and devices are shown in block diagram form to avoid obscuring teachings of the present disclosure. Some portions of the detailed descriptions which follow are presented in terms of procedures, logic blocks, processing and other symbolic representations of operations on data bits within a computer memory. These descriptions and representations are the means used by those skilled in the data processing arts to most effectively convey the substance of their work to others skilled in the art. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, circuits, and steps are described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example devices may include components other than those shown, including well-known components such as a processor, memory and the like.

Aspects of the present disclosure are applicable to any suitable electronic (such as smartphones, tablets, laptop computers, digital cameras, web cameras, a security system, automobiles, drones, aircraft, and so on) that includes two or more cameras, and may be implemented in electronics having a variety of camera configurations. For example, the cameras may have similar or different capabilities (such as resolution, color or black and white, wide angle or telescoping views, same or different zoom capabilities, and so on). The cameras may also include a primary camera and one or more auxiliary cameras. While described below with respect to a device including two cameras, aspects of the present disclosure are applicable to any number of cameras and camera configurations, and are therefore not limited to two cameras (such as a dual camera device).

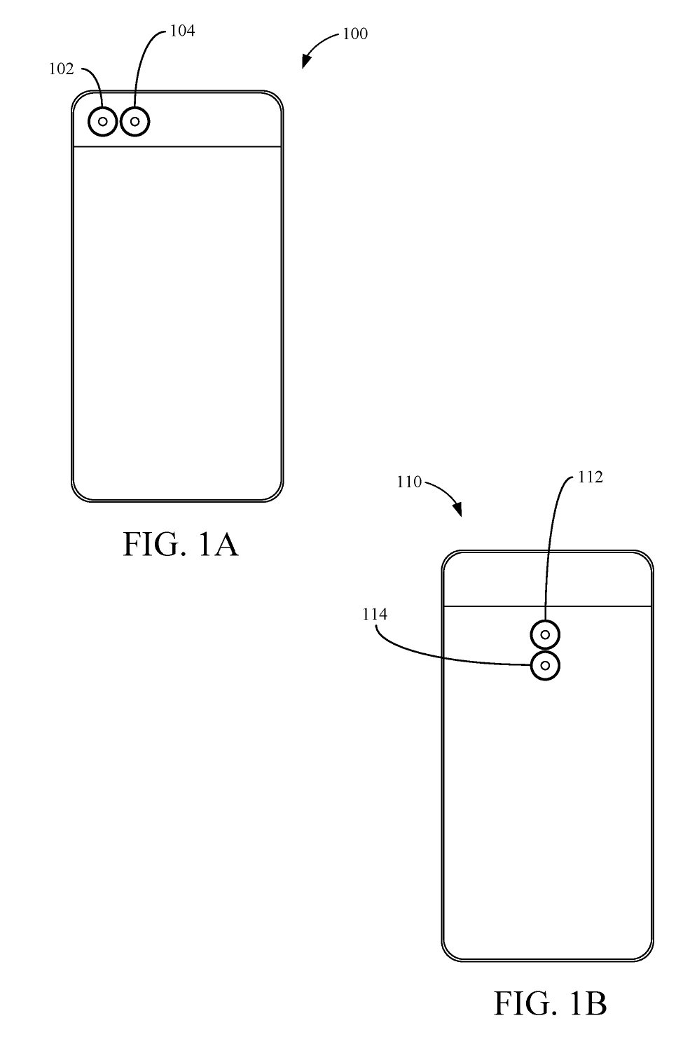

FIG. 1A depicts an example device 100 including a dual camera with a first camera 102 and a second camera 104 arranged in a first configuration. For another example, FIG. 1B depicts another example device 110 including a dual camera with a first camera 112 and a second camera 114 in a second configuration. In some aspects, one of the cameras (such as the first cameras 102 and 112) may be a primary camera, and the other camera (such as the second cameras 104 and 114) may be an auxiliary camera. Additionally or alternatively, the second cameras 104 and 114 may have a different focal length, capture rate, resolution, color palette (such as color versus black and white), and/or field of view or capture than the first cameras 102 and 112.

The term “device” is not limited to one or a specific number of physical objects (such as one smartphone). As used herein, a device may be any electronic with multiple parts that may implement at least some portions of this disclosure. For one example, a device may be a video security system including one or more hubs and two or more separate cameras. For another example, a device may be a smartphone including two cameras such as, for example, the example devices 100 and 110 of FIGS. 1A and 1B, respectively. While the below description and examples use the term “device” to describe various aspects of this disclosure, the term “device” is not limited to a specific configuration, type, or number of objects.

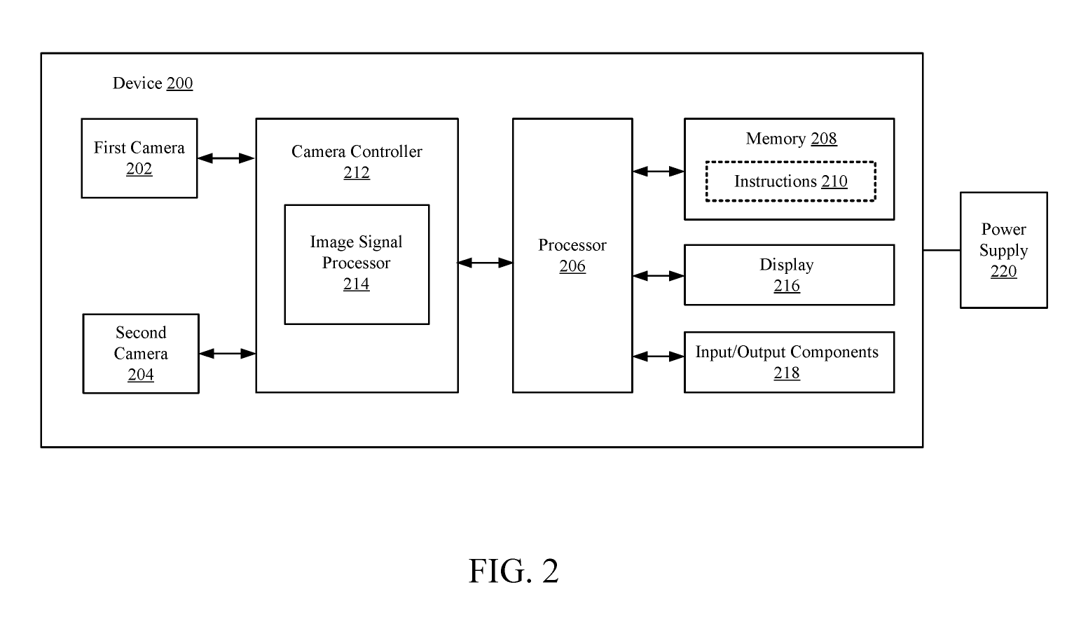

FIG. 2 is a block diagram of an example device 200 including multiple cameras 202 and 204. The example device 200, which may be one implementation of the devices 100 and 110 of FIGS. 1A and 1B, may be any suitable device capable of capturing images or video including, for example, wired and wireless communication devices (such as camera phones, smartphones, tablets, security systems, dash cameras, laptop computers, desktop computers, automobiles, drones, aircraft, and so on), digital cameras (including still cameras, video cameras, and so on), or any other suitable device. The example device 200 is shown in FIG. 2 to include a first camera 202, a second camera 204, a processor 206, a memory 208 storing instructions 210, a camera controller 212, a display 216, and a number of input/output (I/O) components 218. The device 200 may include additional features or components not shown. For example, a wireless interface, which may include a number of transceivers and a baseband processor, may be included for a wireless communication device. Device 200 may include additional cameras other than the first camera 202 and the second camera 204. The disclosure should not be limited to any specific examples or illustrations, including example device 200.

The first camera 202 and second camera 204 may be capable of capturing individual image frames (such as still images) and/or capturing video (such as a succession of captured image frames). The first camera 202 and second camera 204 also may include one or more image sensors (not shown for simplicity) and shutters for capturing an image frame and providing the captured image frame to the camera controller 212.

The memory 208 may be a non-transient or non-transitory computer readable medium storing computer-executable instructions 210 to perform all or a portion of one or more operations described in this disclosure. The device 200 may also include a power supply 220, which may be coupled to or integrated into the device 200.

The processor 206 may be one or more suitable processors capable of executing scripts or instructions of one or more software programs (such as instructions 210) stored within memory 208. In some aspects, the processor 206 may be one or more general purpose processors that execute instructions 210 to cause the device 200 to perform any number of functions or operations. In additional or alternative aspects, the processor 206 may include integrated circuits or other hardware to perform functions or operations without the use of software. While shown to be coupled to each other via the processor 206 in the example of FIG. 2, the processor 206, memory 208, camera controller 212, the display 216, and I/O components 218 may be coupled to one another in various arrangements. For example, the processor 206, memory 208, camera controller 212, the display 216, and/or I/O components 218 may be coupled to each other via one or more local buses (not shown for simplicity).

The display 216 may be any suitable display or screen allowing for user interaction and/or to present items (such as captured images and video) for viewing by a user. In some aspects, the display 216 may be a touch-sensitive display. The I/O components 218 may be or include any suitable mechanism, interface, or device to receive input (such as commands) from the user and to provide output to the user. For example, the I/O components 218 may include (but are not limited to) a graphical user interface, keyboard, mouse, microphone and speakers, and so on.

The camera controller 212 may include an image signal processor 214, which may be one or more image signal processors to process captured image frames or video provided by the first camera 202 and/or the second camera 204. In some example implementations, the camera controller 212 (such as image signal processor 214) may control operation of the first camera 202 and the second camera 204. In some aspects, the image signal processor 214 may execute instructions from a memory (such as instructions 210 from memory 208 or instructions stored in a separate memory coupled to the image signal processor 214) to control operation of the cameras 202 and 204. In other aspects, the image signal processor 214 may include specific hardware to control operation of the cameras 202 and 204. The image signal processor 214 may alternatively or additionally include a combination of specific hardware and the ability to execute software instructions.

Prior to capturing image frames or video, the camera is initialized to determine initial capture settings for the camera. Irrespective of the number of cameras that are used or are initialized (such as a device with a single camera, a device with a dual camera, and so on), the initial capture settings for the camera are typically determined based on the camera's own image captures. Example capture settings may include an automatic exposure setting, an automatic white balance setting, an initial focal length setting, whether to use flash, a frame rate, and so on. For example, when a camera is initialized, the camera is powered on, and initial frames captured by the camera at the default capture settings are used to determine the initial capture settings. For devices that include a user display, the user display may not show previews during initialization of the camera to provide a better user experience (such as image captures not being shown until the captures are acceptable to an average person's perception). Instead, the initial capture settings are determined, and initialization of the camera typically completes before the display previews any images captured by the camera. As such, the initialization of the camera, relying solely on the camera being initialized, can take a significant amount of time, which can reduce the user experience and/or cause delays in capturing images by the camera.

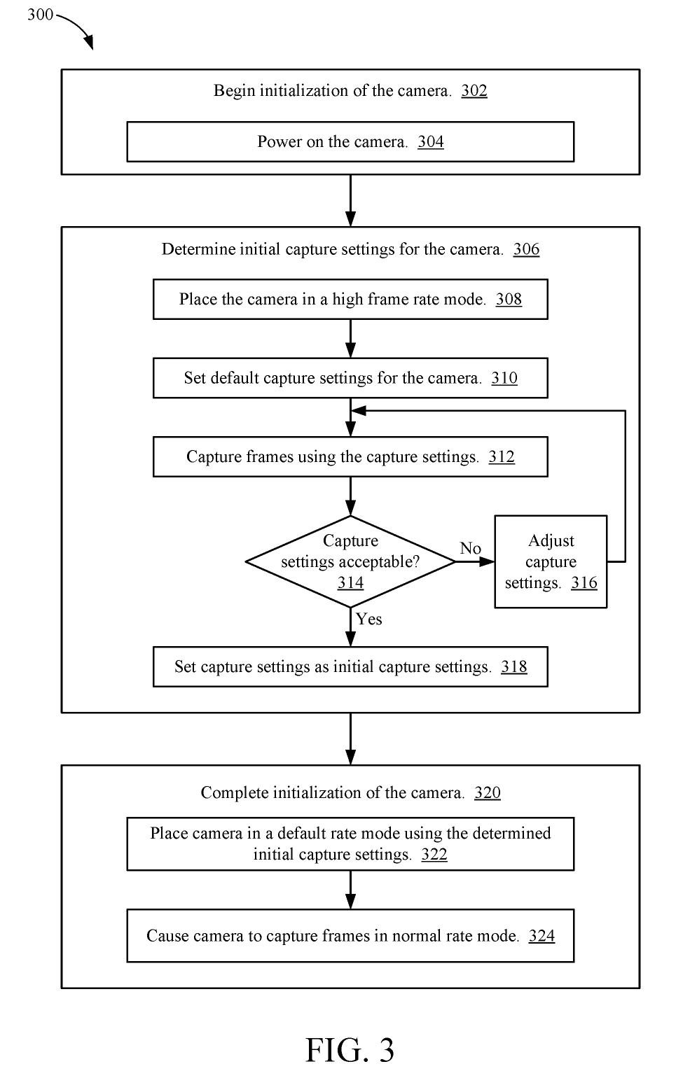

FIG. 3 is an illustrative flow chart depicting an example operation 300 for initializing a camera. The example operation 300 is described below with respect to initializing the first camera 202 of device 200 using only image frames captured from the first camera 202. The device 200 begins initialization of first camera 202 (302). For example, the camera controller 212 of device 200 causes the first camera 202 to power on or otherwise have the device 200 supply power to begin initialization of the first camera 202 (304). With the first camera 202 powered on, the device 200 (such as the camera controller 212) determines initial capture settings for the first camera 202 (306).

For at least some capture settings, such as automatic exposure (AE) and automatic white balance (AWB), the device 200 enters a recursive process of capturing one or more image frames, analyzing the image frames, adjusting the applied settings based on the analysis (such as adjusting the default settings), and then repeating captures, measurements and adjustments until one or more initial capture settings are determined for the first camera 202. An AE setting may be used to control the amount of time the first camera's shutter is open (allowing light to be received by the camera sensor). An AWB setting may be an adjustment to the color balance of an image (such as to prevent the colors of an image being saturated or muted). For example, in determining an initial AE setting, the device 200 may determine if an image is too light or too dark (such as measuring the luminance of an image capture against one or more thresholds). The device 200 adjusts the AE setting, captures one or more additional image frames, and analyzes the captured image frames until the luminance of the image capture falls within an acceptable range.

In determining an initial AWB setting, the device 200 may determine if the colors are saturated or muted (such as measuring the color balance of at least a portion of the captured image frame, which may include a blue/green color ratio and/or a red/green color ratio, against one or more thresholds). The device 200 adjusts the AWB setting, captures one or more additional image frames, and analyzes the captured image frames until the color balance of the image capture falls within an acceptable range. The device 200 may determine multiple capture settings (such as an AE setting and an AWB setting) concurrently or in sequence.

Many cameras are able to capture image frames at different frame rates. For example, some cameras have at least a high frame rate (HFR) mode and a default (or normal) frame rate mode (such as 60, 120, or 240 frames per second and 15, 24, or 30 frames per second, respectively). Recursively capturing image frames and analyzing those frames during initialization may be time consuming. To reduce the amount of time needed to initialize the camera, the device 200 may place the first camera 202 into a higher frame rate (such as an HFR mode) to determine the initial capture settings (which may include recursion of capturing and analyzing image captures). Once the initial capture settings are determined using the higher frame rate (such as an HFR mode), the device 200 may place the first camera 202 into a lower frame rate (such as a default frame rate mode) and apply the initial capture settings determined at the higher frame rate.

Referring also to FIG. 3, in determining the initial capture settings for the first camera 202 (306), the device 200 may place the first camera 202 in a HFR mode (308). In other implementations, the example operation 300 may be used to initialize the second camera 204 of device 200 (using only image frames captured from the second camera 204). In the HFR mode, default capture settings may be set for the first camera 202 (310). For example, the device 200 may use the same default capture settings (such as a default AE setting and default AWB setting) each time the first camera 202 is initialized. The device 200 then causes the first camera 202 to capture one or more image frames using the capture settings (312).

Based on the captured image frames, the device 200 determines if the current capture settings are acceptable (314). For example, for an AE setting, if the captured image frames are too dark or too light (such as the luminance of the image is below a lower threshold or above an upper threshold), the device 200 determines that the current AE setting is not acceptable. In another example, the device 200 may determine that a current AWB setting is not acceptable if the colors are saturated or muted (such as by measuring and comparing a color balance for the captured image frame). Additionally or alternatively, in determining that the AWB setting is not acceptable, the device 200 may determine that the blue/green color ratio and/or the red/green color ratio of the image is not as expected (such as not within a threshold range).

If one or more of the used capture settings are not acceptable, the device 200 may adjust the capture settings (316). The device 200 then causes the first camera 202 to capture one or more first image frames using the adjusted capture settings (312). Thereafter, if the adjusted capture settings are determined to be acceptable (314), the device 200 sets the adjusted capture settings as the initial capture settings for the first camera 202 (318).

Once the initial capture settings for the first camera 202 are determined, the device 200 may complete initialization of the first camera 202 (320). For example, the device 200 may cause the first camera 202 to be switched from an HFR mode to a default rate mode and apply the determined capture settings as the initial capture settings (322). The device 200 may then cause the first camera 202 to begin capturing image frames in the default rate mode using the determined capture settings (324). If the display 216 was prevented from previewing the stream from the first camera 202, the display 216 may be enabled to preview image captures from the first camera 202 in the default rate mode using the initial capture settings.

By placing the first camera 202 into a HFR mode or a default rate mode, the device 200 may configure the camera sensor and one or more image signal processors (such as image signal processor 214). Configuring the camera sensor and image signal processor may take tens to hundreds of milliseconds, and is performed whenever the camera is placed into a new mode. Additionally, converging to initial capture settings (such as AE or AWB settings) in HFR mode takes many tens to hundreds of milliseconds.

In some aspects, a device (such as device 200) may leverage a second camera (such as camera 204 of FIG. 2) to determine the initial capture settings for the first camera 202. In determining the initial capture settings from image captures by the second camera 204, the first camera 202 may not be placed into the HFR mode to determine the initial capture settings during initialization. For example, the device 200 may use image captures from the second camera 204 to determine the initial capture settings for the first camera 202, and the first camera 202 may be placed directly into the normal rate mode during initialization without first being placed into a HFR mode.

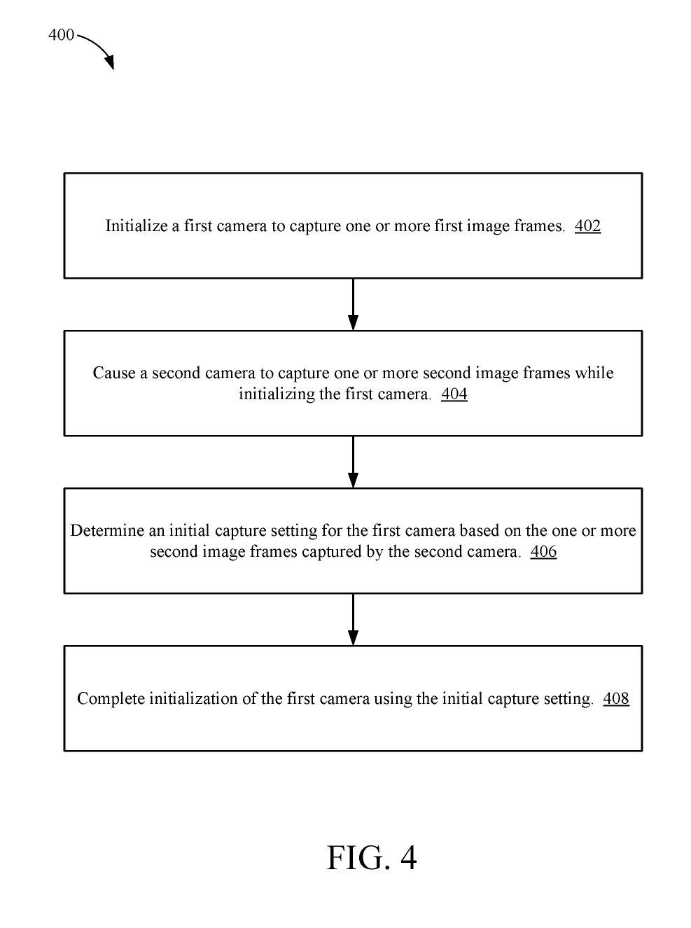

FIG. 4 is an illustrative flow chart depicting an example operation 400 for initializing a first camera based at least in part on images captured by a second camera. In some other implementations, a module with three or more cameras may be used. The third camera may be initialized contemporaneously with the first camera. Alternatively, the third camera may be in a power save mode or already initialized during initialization of the first camera. One or more additional cameras for a module with more than three cameras also may be initialized contemporaneously with the first camera by the device, be in a power save mode during initialization of the first camera, or already be initialized during initialization of the first camera.

The example operation 400 is described below with respect to initializing the first camera 202 of device 200 using image frames captured by the second camera 204 of device 200. Beginning at 402, the device 200 begins initialization of the first camera 202, for example, so that the first camera can capture one or more first image frames. While the first camera 202 is being initialized, the device 200 may cause the second camera 204 to capture one or more second image frames (404). The device 200 may then determine, for the first camera 202, one or more initial capture settings based on the one or more second image frames captured by the second camera 204 (406). The device 200 then completes initialization of the first camera 202 by determining and applying the initial capture settings to the first camera 202 (408).

In some example implementations, the device 200 places the second camera 204 through a recursive process of capturing one or more image frames, analyzing the one or more image frames, and adjusting the one or more capture settings until the capture settings are acceptable. In some aspects, the recursive process may be similar to steps 308-318 in FIG. 3. In this manner, the device 200 performs the recursive process of converging the initial capture settings (such as AE and AWB settings) of the first camera 202 using image frames captured by the second camera 204.

In some implementations, the device 200 may reduce camera initialization latencies by not configuring the camera sensor and image signal processor for the first camera 202 multiple times. The device 200 may also reduce camera initialization latencies by not using the first camera 202 to perform all image captures in determining the one or more initial capture settings. In this manner, the latency between launching the camera function (such as activating or selecting a camera function on a smartphone or digital camera) and completing initialization of the camera may be reduced (such as compared with conventional camera initialization techniques), thereby improving the user experience. It is noted that aspects of the present disclosure also apply to devices other than smartphones and digital cameras (such as video security systems, automobiles, drones, and aircraft).

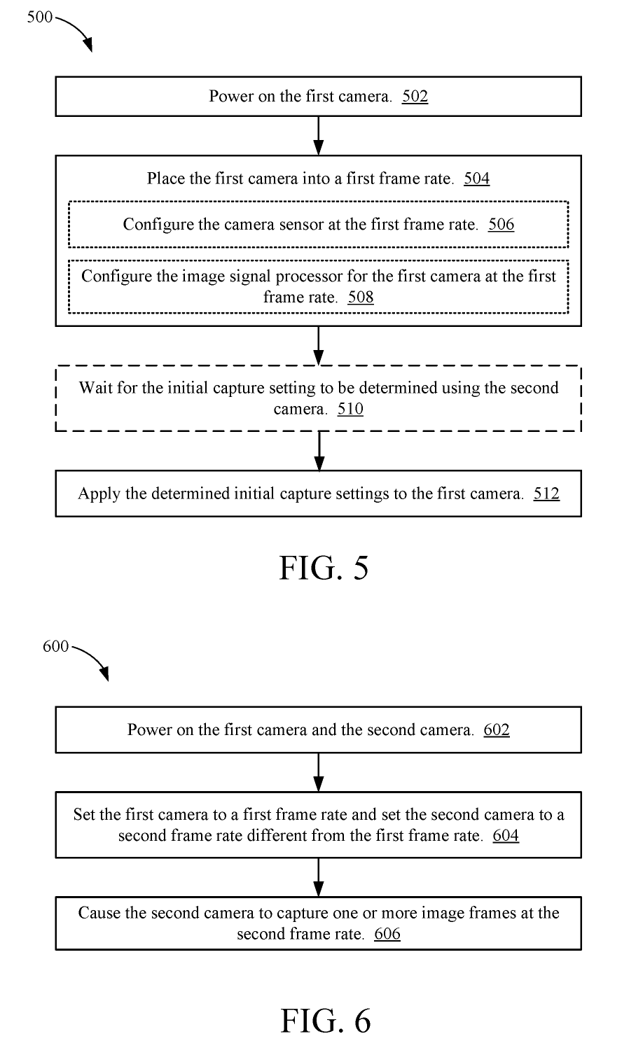

FIG. 5 is an illustrative flow chart depicting an example operation for initializing a first camera to capture image frames at a first frame rate. The example operation 500 is described below with respect to initializing the first camera 202 of device 200 without being placed into a second frame rate different from the first frame rate (such as a default rate mode without being placed into an HFR mode). Beginning at 502, the device 200 may power on or otherwise enable or supply power to the first camera 202. The device 200 then places the first camera 202 into a first frame rate (504). For example, the device 200 may place the first camera 202 into a default frame rate mode in which the first camera 202 is being initialized to capture image frames for later use or storage. In some aspects, the device 200 may optionally configure the camera sensor of the first camera 202 at the first frame rate (506). The device 200 may also optionally configure an image signal processor for the first camera 202 (such as image signal processor 214) at the first frame rate (508).

With the first camera 202 placed into the first frame rate (such as by configuring the camera sensor and image signal processor), the first camera 202 may be configured to capture image frames before one or more initial capture settings are determined for the first camera 202 (such as determining the initial capture settings using image frame captures from the second camera 204). The device 200 may optionally wait to use the first camera 202 until the initial capture settings for the first camera 202 are determined (510). For example, the first camera 202 may be idle until the device 200 determines the one or more initial capture settings and then sets or applies the one or more initial capture settings to the first camera 202 (512). If the one or more initial capture settings are determined before the first camera 202 is placed into the first frame rate, the device 200 may apply or set the one or more capture settings for the first camera 202 (512) without waiting.

In some example implementations, the second camera 204 may already be initialized before the first camera 202 is initialized by device 200. In some other example implementations, the first camera 202 and the second camera 204 may be initialized concurrently. For example, in some aspects, the first and second cameras 202 and 205 (such as in a smartphone having dual cameras) may share the same power supply. In this matter, when power is not supplied to the first camera 202, power is also not supplied to the second camera 204. Conversely, when power is supplied to the first camera 202, power may also be supplied to the second camera 204 of the device 200.

FIG. 6 is an illustrative flow chart depicting an example operation 600 for concurrently initializing a first camera and a second camera of a device. The example operation 600 is described below with respect to initializing the first camera 202 and the second camera 204 of device 200 at the same time, for example, so that the first camera 202 may capture one or more first image frames, and the second camera 204 may capture one or more second image frames. Beginning at 602, the device 200 may power on or supply power to both the first camera 202 and the second camera 204. The device 200 may then set the first camera 202 to a first frame rate (such as a default frame rate mode) and set the second camera 204 to a second frame rate different from the first frame rate (such as an HFR mode) (604). Since the second camera 204 is to be used to determine one or more initial capture settings for the first camera 202, the device 200 may cause the second camera 204 to capture one or more second image frames at the second frame rate (606). In capturing the one or more second image frames at the second frame rate (such as an HFR mode), the device 200 may initially use default capture settings for the second camera 204, which in turn may be adjusted during determination of the one or more initial capture settings.

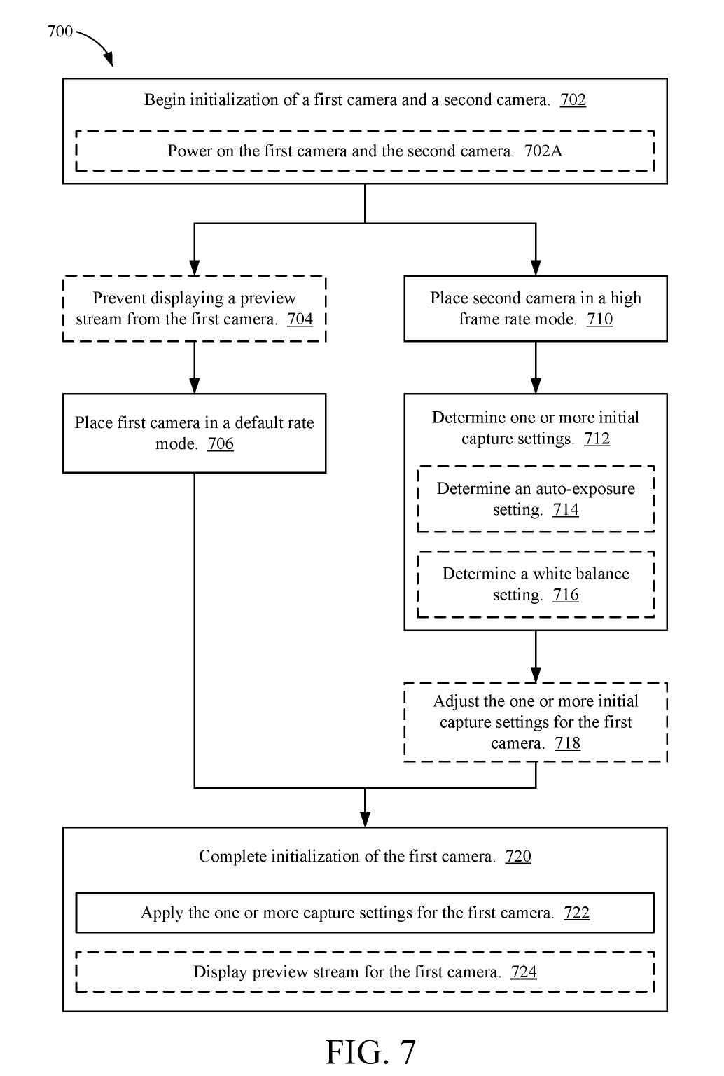

FIG. 7 is an illustrative flow chart depicting another example operation 700 for concurrently initializing a first camera and a second camera of a device. The example operation 700 is described below with respect to initializing the first camera 202 and the second camera 204 of device 200 at the same time, for example, so that the first camera 202 may capture one or more first image frames, and the second camera 204 may capture one or more second image frames. Beginning at 702, the device 200 begins initialization of the first camera 202 and the second camera 204. For example, the device 200 may power on the first camera 202 and the second camera 204, concurrently (702A). In some example embodiments, the device 200 may optionally prevent a display 216 from previewing the stream or captures from the first camera 202 until the initialization of the first camera 202 is complete (704). For example, the display 216 may show a black background, loading screenshot, stay powered off, and so on, while the first camera 202 completes initialization.

In initializing the first camera 202, the device 200 may place the first camera 202 into a default frame rate mode (706). For example, the device 200 may configure the camera sensor and the image signal processor for the first camera 202 in the default frame rate mode (similar to steps 506 and 508 in example operation 500 in FIG. 5). While the first camera 202 is placed into the default frame rate mode, the device 200 may place the second camera 204 into an HFR mode (710). The device 200 then uses the second camera 204 to determine one or more initial camera settings for the first camera 202 (712). In determining one or more initial capture settings (712), the device 200 may optionally determine an AE setting (714) and optionally determine an AWB setting (716).

Since the second camera 204 is being initialized concurrently with the first camera 202, the device 200 may initialize the second camera 204 to determine one or more initial capture settings for both the first camera 202 and the second camera 204. For example, in determining an AE setting and/or an AWB setting (or other capture settings), the device 200 may use the second camera 204 to perform steps 310-318 of example operation 300 (FIG. 3) to determine initial capture settings for the second camera 204, which are used to determine the initial capture settings for the first camera 202. The device 200 first may use default capture settings (such as a default AE setting and a default AWB setting) for the second camera 204 to capture one or more image frames. The device 200 may then recursively adjust the capture settings and capture more image frames until the capture settings are acceptable (recursively performing steps 312-316). For example, in determining that an AE setting is acceptable, the device 200 may determine that the luminance of the captured image frame is within a defined range. In determining that an AWB setting is acceptable, the device 200 may determine that the color balance of the captured image frame is within a defined range (such as a blue/green color ratio and a red/green color ratio of the image being within defined ranges). In this manner, the initial capture settings for the second camera 204 may be determined, and those capture settings may be adjusted to be used for the first camera 202.

If the first camera 202 is the same type of camera as the second camera 204 (such as having the same specifications or being the same model of camera), the initial capture settings determined for the second camera 204 may be the same as the initial capture settings for the first camera 202. In some example implementations, the device 200 may adjust the determined initial capture settings for the first camera 202 (718). For example, the capture settings may be adjusted to compensate for the different frame rate modes (such as if the difference in frame rates between the HFR mode and the default frame rate mode affects the luminance or color balance of the captured image frames).

Additionally or alternatively, if there are differences between the first camera 202 and the second camera 204 (such as different fields of view, color palettes, resolutions, and so on), the device 200 may optionally adjust the determined capture settings based on the differences. In this manner, the determined capture settings may be applied for the second camera 204, and the adjusted capture settings may be applied for the first camera 202.

In some example implementations for adjusting the capture settings, the device 200 may include a look up table in a memory (such as memory 208 or a memory coupled to the camera controller 212). The device 200 may use the look up table to convert the determined capture settings for the first camera 202. For example, if the second camera 204 is a telescoping or telephoto camera while the first camera is a wide view camera, the AE setting or AWB setting may need to be increased to account for the wider field of view. In this manner, the device 200 may use a look up table to determine that one or more of the determined AE and AWB settings are to be increased before being applied for the first camera 202.

After the one or more capture settings are determined for the first camera 202, the device 200 may complete initialization of the first camera 202 (720). In completing initialization of the first camera 202, the device 200 may apply the one or more capture settings (such as the determined capture settings or the adjusted capture settings) for the first camera 202 (722). The device 200 may also cause the first camera 202 to begin capturing one or more image frames using the one or more applied capture settings. If the display 216 is not providing a preview of the stream from the first camera 202 until initialization of the first camera 202 is complete, the device 200 may optionally enable the display 216 to provide a preview of the stream for the first camera 202 (724).

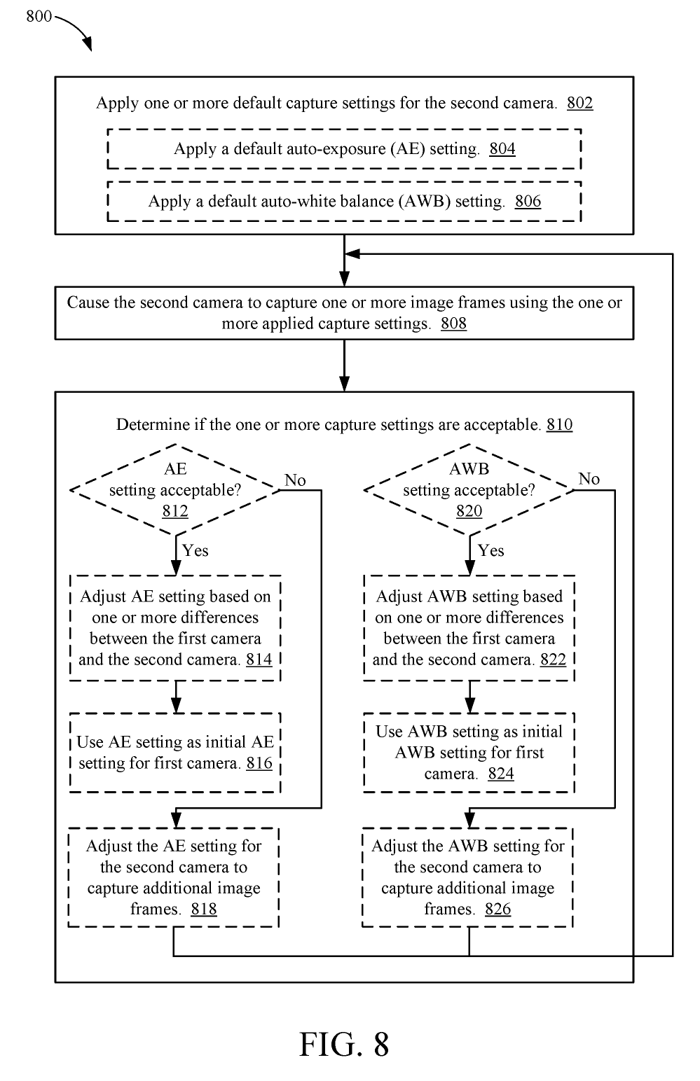

FIG. 8 is an illustrative flow chart depicting an example operation 800 for determining one or more initial capture settings for a first camera during initialization. The example operation 800, which is described below with respect to the first camera 202 of device 200, may be one implementation of steps 712-718 in the example operation 700 (FIG. 7). As described above with respect to FIGS. 3-7, the first camera 202 may be initialized to capture one or more first image frames, and the second camera 202 may be initialized to capture one or more second image frames. Beginning at 802, the device 200 may apply one or more default capture settings to the second camera 204. In some aspects, the device 200 may use the same capture settings each time as the default capture settings. In other aspects, the device 200 may use the last determined capture settings as the default capture settings. In some other aspects, the device 200 may use a combination of previously used default capture settings and previously determined initial capture settings. For example, the device 200 may apply a default AE setting that is stored in a memory (such as memory 208 or a memory coupled to the camera controller 212) (804). The device may alternatively or additionally apply a default AWB setting that is stored in memory (such as the memory 208 of FIG. 2) (806).

With the one or more capture settings applied to the second camera 204, the device 200 may cause the second camera 204 to capture one or more second image frames using the one or more applied capture settings (808). The device 200 may then determine, from the one or more second image frames captured by the second camera 204, if the one or more applied capture settings (such as an AE setting and/or an AWB setting) are acceptable (810). For example, the device 200 may optionally perform steps 812-818 to determine if an applied AE setting is acceptable. The device 200 may optionally perform steps 820-826 to determine if an applied AWB setting is acceptable. As shown, steps 812-818 may be performed concurrently with steps 820-826. However, the present disclosure should not be limited to the illustrated examples and determining capture settings concurrently, as capture settings may alternatively be determined in sequence.

For an applied AE setting, the device 200 determines if the applied AE setting is acceptable (812). In some aspects, the device 200 determines an overall luminance of a captured image frame and determines if the luminance is within a defined range (such as above a lower threshold and below an upper threshold). If the AE setting is acceptable, the device 200 may optionally adjust the AE setting for the first camera 202 based on differences between features or settings of the first camera 202 and features or settings of the second camera 204 (814). In some aspects, the device 200 may adjust the AE setting based on the difference in frame rates of the first and second cameras 202 and 204 (with the second camera 204 being in an HFR mode and the first camera 202 being in a default frame rate mode). In other aspects, the device 200 may adjust the AE setting based on a difference in field of view, resolution, color palette, and so on. For example, the device 200 may use a look up table to determine an adjusted AE setting from the applied AE setting. The look up table may be stored in, or associated with, the memory 208 of the device 200. The device 200 may then use the adjusted AE setting as the initial AE setting for the first camera 202 (816).

If the AE setting is not acceptable (such as the luminance being outside a defined range), as tested at 812, the device 200 may adjust the AE setting so that additional image frames may be captured to determine an acceptable AE setting (818). For example, if the luminance is below a lower threshold (such as the image is too dark), the device 200 may increase the AE setting so that the camera shutter stays open longer to allow more light to be received by the camera sensor. Alternatively, if the luminance is above an upper threshold (such as the image is too bright), the device 200 may decrease the AE setting so that the camera shutter closes sooner to reduce the amount of light to be received by the camera sensor.

Concurrently or sequentially, the device 200 may determine if the AWB setting is acceptable (820). For example, the device 200 may determine if the overall color balance for the captured image frame is within a defined range. In some example implementations, the device 200 may select a portion of the scene that is to be white or off-white. The device 200 may then determine the difference between the expected color of the selected portion and the measured color of the selected portion of the captured image frame. If the difference is above a defined threshold, the device 200 may determine that the applied AWB setting is not acceptable. If the difference is below the defined threshold, the device 200 may determine that the applied AWB setting is acceptable. In some example implementations, the device 200 may compare the measured blue/green color ratio and/or the red/green color ratio for the portion of the captured image frame to the expected ratios in order to determine the difference.

If the AWB setting is acceptable, the device 200 may optionally adjust the AWB setting for the first camera 202 based on differences between features or settings of the first camera 202 and features or settings of the second camera 204 (822). For example, the device 200 may adjust the AWB setting based on the difference in frame rate (with the second camera 204 being in an HFR mode and the first camera 202 being in a default frame rate mode). In some other example embodiments, the device 200 may adjust the AWB setting based on a difference in field of view, resolution, color palette, and so on. For example, the device 200 may use a look up table (which may or may not be the same look up table for the AE settings) to determine an adjusted AWB setting from the applied AWB setting. The device 200 may then use the adjusted AWB setting as the initial AWB setting for the first camera 202 (824).

If the AWB setting is not acceptable (such as the measured color balance being outside a defined range), as tested at 820, the device 200 may adjust the AWB setting so that additional image frames may be captured to determine an acceptable AWB setting (826). For example, if the blue/green ratio or the red/green ratio for the portion of the captured image frame is above an upper threshold (the image is too blue or too red), the device 200 may adjust the AWB setting so that the device 200 reduces the blue color or red color in the captured images. Alternatively, if the blue/green ratio or the red/green ratio for the portion of the captured image frame is below a lower threshold (such as the image is too green compared to blue or red), the device 200 may adjust the AWB setting, for example, so that the device 200 increases the blue color or red color in the captured images.

If one or more of the capture settings are not acceptable (such as the AE setting being unacceptable and/or the AWB being unacceptable) and are adjusted in response thereto (as described in steps 818 and/or 826), the device 200 causes the second camera 204 to capture one or more additional image frames using the one or more adjusted capture settings (808). The process may repeat until all of the one or more capture settings are acceptable. One or more of multiple capture settings may settle or be acceptable before the other capture settings. In some example implementations, the device 200 may not adjust the acceptable capture settings, and may repeat the process for the remaining capture settings until all of the capture settings are acceptable.

The techniques described herein may be implemented in hardware, software, firmware, or any combination thereof, unless specifically described as being implemented in a specific manner. For example, the described various processes and determinations may be implemented as specialty or integrated circuits in an image signal processor, as software (such as instructions 210) to be executed by the image signal processor 214 (which may be one or more image signal processors) of camera controller 212 or a processor 206 (which may be one or more processors), or as firmware. Any features described may also be implemented together in an integrated logic device or separately as discrete but interoperable logic devices. If implemented in software, the techniques may be realized at least in part by a non-transitory processor-readable storage medium (such as memory 208) comprising instructions (such as instructions 210 or other instructions accessible by one or more image signal processors 214) that, when executed by one or more processors (such as processor 206 or one or more image signal processors in a camera controller 212), performs one or more of the methods described above. The non-transitory processor-readable data storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

The various illustrative logical blocks, modules, circuits and instructions described in connection with the embodiments disclosed herein may be executed by one or more processors, such as processor 206 in FIG. 2 or image signal processor 214 that may be provided within camera controller 212. Such processor(s) may include but are not limited to one or more digital signal processors (DSPs), general purpose microprocessors, application specific integrated circuits (ASICs), application specific instruction set processors (ASIPs), field programmable gate arrays (FPGAs), or other equivalent integrated or discrete logic circuitry. The term “processor,” as used herein may refer to any of the foregoing structures or any other structure suitable for implementation of the techniques described herein. In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any conventional processor, controller, microcontroller, or state machine. A processor may also be implemented as a combination of computing devices, such as a combination of a DSP and a microprocessor, a plurality of microprocessors, one or more microprocessors in conjunction with a DSP core, or any other such configuration.

While the present disclosure shows illustrative aspects, it should be noted that various changes and modifications could be made herein without departing from the scope of the appended claims. Additionally, the functions, steps or actions of the method claims in accordance with aspects described herein need not be performed in any particular order unless expressly stated otherwise. Furthermore, although elements may be described or claimed in the singular, the plural is contemplated unless limitation to the singular is explicitly stated. Accordingly, the disclosure is not limited to the illustrated examples, and any means for performing the functionality described herein are included in aspects of the disclosure.

What is claimed is:

1. A device, comprising:
a camera controller coupled to a first camera and a second camera, the camera controller configured to:
initialize the first camera to capture one or more first image frames;
cause the second camera to capture one or more second image frames while initializing the first camera;
determine an initial capture setting for the first camera based on the one or more second image frames captured by the second camera; and
complete initialization of the first camera using the initial capture setting.

2. The device of claim 1, wherein the camera controller is further configured to:
cause the first camera to capture the one or more first image frames at a first frame rate when initializing the first camera, wherein the second camera captures the one or more second image frames at a second frame rate higher than the first frame rate.

3. The device of claim 2, wherein:
the first frame rate is a default frame rate for the device.

4. The device of claim 1, wherein the camera controller is further configured to:
initialize the second camera, concurrently with initializing the first camera, by causing the second camera to capture the one or more second image frames.

5. The device of claim 4, wherein:
initializing the first camera comprises powering on the first camera; and
initializing the second camera further comprises powering on the second camera.

6. The device of claim 5, wherein the camera controller is further configured to power on the first camera and the second camera concurrently.

7. The device of claim 1, wherein the camera controller is further configured to:
adjust the initial capture setting based on differences between one or more features of the first camera and one or more features of the second camera before completing initialization of the first camera.

8. The device of claim 1, wherein the camera controller is configured to complete initialization of the first camera by:
applying the initial capture setting to the first camera;
capturing the one or more first image frames using the first camera; and
adjusting the applied initial capture setting based on the one or more first image frames captured by the first camera.

9. The device of claim 1, wherein the initial capture setting is at least one from the group consisting of:
an auto-exposure setting; and
a white balance setting.

10. The device of claim 1, wherein the first camera is a primary camera and the second camera is an auxiliary camera of the device.

11. The device of claim 1, further comprising a dual camera module including the first camera and the second camera.

12. The device of claim 1, wherein the camera controller is further configured to prevent a display of the device from displaying a preview for the first camera until after completing the initialization of the first camera.

13. A method for initializing a number of cameras in a multiple camera setup, comprising:
initializing a first camera to capture one or more first image frames;
causing a second camera to capture one or more second image frames while initializing the first camera;
determining an initial capture setting for the first camera based on the one or more second image frames captured by the second camera; and
completing initialization of the first camera using the initial capture setting.

14. The method of claim 13, further comprising:
causing the first camera to capture the one or more first image frames at a first frame rate when initializing the first camera, wherein the second camera captures the one or more second image frames at a second frame rate higher than the first frame rate.

15. The method of claim 14, wherein:
the first frame rate is a default frame rate.

16. The method of claim 13, further comprising:
initializing the second camera, concurrently with initializing the first camera, by causing the second camera to capture the one or more second image frames.

17. The method of claim 16, wherein:
initializing the first camera comprises powering on the first camera; and
initializing the second camera further comprises powering on the second camera.

18. The method of claim 13, further comprising:
adjusting the initial capture setting based on differences between one or more features of the first camera and one or more features of the second camera before completing initialization of the first camera.

19. The method of claim 13, wherein completing initialization of the first camera comprises:
applying the initial capture setting to the first camera;
capturing the one or more first image frames using the first camera; and
adjusting the applied initial capture setting based on the one or more first image frames captured by the first camera.

20. The method of claim 13, wherein the initial capture setting is at least one from the group consisting of:
an auto-exposure setting; and
a white balance setting.

21. A non-transitory computer-readable storage medium storing one or more programs containing instructions that, when executed by one or more processors of a device, cause the device to perform a number of operations comprising:
initializing a first camera to capture one or more first image frames;
causing a second camera to capture one or more second image frames while initializing the first camera;
determining an initial capture setting for the first camera based on the one or more second image frames captured by the second camera; and
completing initialization of the first camera using the initial capture setting.

22. The non-transitory computer-readable storage medium of claim 21, wherein execution of the instructions further causes the device to perform operations further comprising:
causing the first camera to capture the one or more first image frames at a first frame rate when initializing the first camera, wherein the second camera captures the one or more second image frames at a second frame rate higher than the first frame rate.

23. The non-transitory computer-readable storage medium of claim 22, wherein:
the first frame rate is a default frame rate.

24. The non-transitory computer-readable storage medium of claim 21, wherein execution of the instructions causes the device to perform operations further comprising:
initializing the second camera, concurrently with initializing the first camera, by causing the second camera to capture the one or more second image frames.

25. The non-transitory computer-readable storage medium of claim 21, wherein execution of the instructions causes the device to perform operations further comprising:
adjusting the initial capture setting based on differences between one or more features of the first camera and one or more features of the second camera before completing initialization of the first camera.

26. The non-transitory computer-readable storage medium of claim 21, wherein the initial capture setting is at least one from the group consisting of:
an auto-exposure setting; and
a white balance setting.

27. A device, comprising:
means for initializing a first camera to capture one or more first image frames;
means for causing a second camera to capture one or more second image frames while initializing the first camera;
means for determining an initial capture setting for the first camera based on the one or more second image frames captured by the second camera; and
means for completing initialization of the first camera using the initial capture setting.

28. The device of claim 27, further comprising:
means for causing the first camera to capture the one or more first image frames at a first frame rate when initializing the first camera, wherein the second camera captures the one or more second image frames at a second frame rate higher than the first frame rate.

29. The device of claim 27, further comprising:
means for initializing the second camera, concurrently with initializing the first camera, by causing the second camera to capture the one or more second image frames.

30. The device of claim 27, further comprising:
means for determining differences between one or more features of the first camera and one or more features of the second camera; and
means for adjusting the initial capture setting based on differences between one or more features of the first camera and one or more features of the second camera before completing initialization of the first camera.
